(19) United States
(12) Patent Application Publication
(10) Pub. No.: US 2022/0259531 A1
(43) Pub. Date: Aug. 18, 2022

(54) METHOD AND APPARATUS FOR PREPARATION OF AN ALCOHOLIC BEVERAGE

(71) Applicant: EMPIRICAL APS, Copenhagen (DK)

(72) Inventor: Lars Williams, Copenhagen (DK)

(21) Appl. No.: 17/622,955

(22) PCT Filed: Jun. 29, 2020
(86) PCT No.: PCT/EP2020/068230

§ 371 Date: Dec. 27, 2021

(30) Foreign Application Priority Data
Jun. 28, 2019 (DK) PA 2019 70416

(51) Int. Cl. C12H 1/16; C12H 6/02

(52) U.S. Cl. CPC C12H 1/165; C12H 6/02

(57) ABSTRACT

The present invention provides a method for preparation of alcoholic beverages obtained from vacuum distilled products. Further, the present invention provides a device useful for carrying out the method.

### FIELD OF THE INVENTION

The present invention relates to a process for manufacturing an alcoholic beverage and an apparatus useful therefor.

### BACKGROUND OF THE INVENTION

Alcoholic beverages contain ethanol (CH₃CH₂OH), a type of alcohol produced by fermentation of grains, fruits, or other sources of sugar. Ingestion of alcoholic beverages plays an important social role in many cultures.

Liquor or spirit is an alcoholic liquid produced by distillation. It may contain various ingredients such as of grains, fruit, or vegetables that have already gone through alcoholic fermentation. The distillation process purifies the liquid and removes diluting components like water as well as undesired higher-order alcohols and the highly toxic methanol.

Generally, the alcohol distillation process is carried out by heating the ethanol containing suspension/solution to a temperature below the boiling point of water—by fine-tuning the temperature, a preferential evaporation of ethanol is attained, which allows condensation of the ethanol-containing vapour and thus providing a distilled liquid (a condensate) enriched in ethanol content. In addition, the distillation parameters further allow various flavouring agents derived from the distillation mixture to be retained in the condensate, because these will be included in the vapour to varying degrees depending on the exact configuration of the distillation apparatus/process.

During this process, the flavours may typically change and since fragile flavours may be destroyed by the heating (e.g. because the temperature of the distillation process exceeds temperature thresholds at which the flavouring compounds remain chemically or structurally stable, the fragile flavours can be oppressed by the less fragile flavours typically leaving a different complex of flavours in the liquor.

Preserving natural flavours in alcoholic beverages is hence not always without obstacles. First of all, certain fragile flavours may disappear completely during the distillation process or their taste and fragrance may be altered significantly. Second, and as a consequence, it may also be impossible or very difficult to preserve the balance in flavours, which characterises the natural products from which the alcoholic beverage has been prepared. As a consequence, some alcoholic beverages are flavoured after distillation, typically with various spices and herbs. However, this technique does not result in a product, which reflects the original fermentation product's flavour characteristics.

### OBJECT OF THE INVENTION

It is an object of embodiments of the disclosure to provide a process for preserving or amending the complex of flavours in liquor and to increase the expression of fragile flavours in liquor.

### SUMMARY OF THE INVENTION

It has been found by the present inventor(s) that careful selection and mixing of vacuum portions of distilled products from an ethanol fermentation and optionally from an acidic fermentation, respectively, provides for superior preservation of flavours in a resulting alcoholic beverage. In particular, the process of the invention can utilise differences in preservation of flavours obtained from these very different fermentation processes and provides for an end product that retains the desired flavours from each of the fermentation products.

So, in a first aspect the present invention relates to a method for preparation of an alcoholic beverage, the method comprising mixing at least one first vacuum distillation condensate and at least one second vacuum distillation condensate, wherein the first vacuum distillation condensates can be or is obtained by the steps of

1) distilling an ethanol-containing fermentation mixture, to produce a primary ethanol-containing distillation condensate, which optionally also contains at least one first flavouring agent derived from the fermentation product,

2) optionally mixing the primary ethanol-containing distillation condensate with at least one second flavouring agent before subjecting the liquid phase of the resulting mixture or, if no second flavouring agent has been used, the primary ethanol-containing distillation condensate to vacuum distillation to obtain a secondary ethanol-containing distillation condensate, which comprises an amount of the at least first flavouring agent or the at least one second flavouring agent or both the at least first and at least second flavouring agent, and

3) recovering the first vacuum distillation condensate in the form of a fraction of the secondary condensate obtained in step 2,

and wherein the second vacuum distillation condensate can be or is obtained by either

a) vacuum distilling a mixture comprising a weak acid and at least one third flavouring agent to produce an acidic distillation condensate, which comprises an amount of the at least one third flavouring agent, and

b) recovering the second vacuum distillation condensate in the form of a fraction from the acidic distillation condensate obtained in step a;

or

c) by steps 1-3, where the second vacuum distillation condensate is recovered in the form of a different fraction of the secondary condensate obtained in step 2 than the fraction constituting the first vacuum distillation condensate.

In a second aspect, the invention relates to device for preparation of an alcoholic beverage, the device comprising
vacuum suction means,
a distillation vessel forming a distillation chamber in fluid communication with the vacuum suction means and configured for subjecting a liquid phase of a primary ethanol-containing mixture to vacuum distillation e.g. to obtain a secondary ethanol-containing distillation condensate, which comprises an amount of at least one first and/or second flavouring agent, and
a condenser structure comprising at least one condenser configured for providing a first vacuum distillation condensate as an fraction of the secondary condensate,

the device further comprising an ultrasonic transducer configured for establishing a mist of the liquid phase of the primary mixture in the vacuum distillation vessel, and

the device further optionally comprising a mixer for mixing a primary ethanol-containing distillation condensate with the second flavouring agent so as to prepare the primary mixture.

In a third aspect, the invention relates to a process for producing an alcoholic beverage, the method comprising subjecting an ethanol-containing liquid derived from a fermentation process to at least one step of vacuum distillation performed at a temperature that does not exceed 40 degrees Celsius, recovering a plurality of ethanol-containing fractions at different time points during the final step of vacuum distillation, and subsequently 1) either combining liquid from at least two of the plurality of ethanol-containing fractions to obtain the final alcoholic beverage 2) or obtaining the final alcoholic beverage from one single of the ethanol-containing fractions.

### LEGENDS TO THE FIGURE

FIG. 1: Flow chart showing the outline of a production process that comprises the distillation process of the invention.

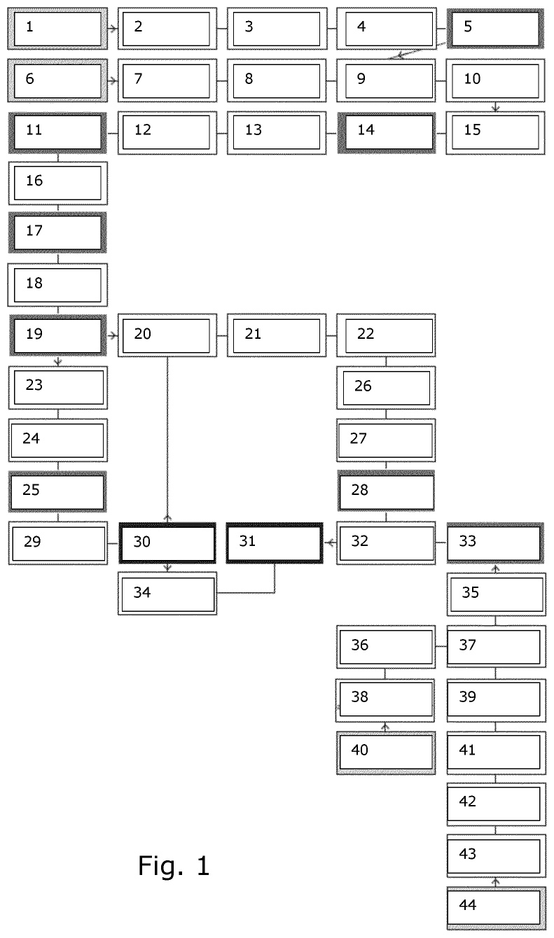

FIG. 2: Schematic drawing of a distillation apparatus of the invention.

### DETAILED DISCLOSURE OF THE INVENTION

### Definitions

When used herein, the term “vacuum” is not considered as an absolute vacuum but rather at low pressure compared to normal atmospheric pressure, e.g. 1% of atmospheric pressure. Typical values range between 1 and 10 Torr.

### Specific Embodiments of the Invention

### Embodiments of the First Aspect of the Invention

As is clear from the above, the method of the invention comprises that at least two different vacuum distilled products are mixed. These at least two different products can both be obtained by the process set forth in steps 1-3, where different fractions from the distillation process are mixed. The at least two different products can also be obtained by mixing products obtained from steps 3 and b, respectively.

Typically, the fermentation product in step 1 is the liquid phase from an ethanol fermentation process; this ethanol fermentation process, of which an example is provided in Example 1, normally aims at providing a fermentation product, which is rich in desirable flavours (“the at least one first flavouring agent”), which are “carried over” in the subsequent distillation processes in steps 1 and 2. In turn, the at least one first flavouring agent is typically a biological product, which optionally has been subjected to fermentation, such as acidic fermentation, where fermentation using acetic acid is the most preferred. It is noted that the distillation in step 1 can be a vacuum distillation as described in more detail below for step 2—all disclosure relating to vacuum distillation in step 2 thus applies mutatis mutandis to the distillation in step 1

In the event the mixing of the primary ethanol-containing distillation condensate and the at least one second flavouring agent takes place, it can, if necessary by followed by an incubation period prior to carrying out the vacuum distillation in step 2—this allows extraction of flavours to the mixture, and as is the case for the at least one first flavouring agent, a carry-over during the distillation in step 2 is hence facilitated. Such an incubation preferably lasts for at most 10 days, such as at most 8 days, at most 7 days, at most 6 days, at most 5 days, at most 4 days, at most 3 day, at most 2 days, and at most 1 days. On the other hand, it will normally constitute at least 10 minutes, such as at least hour, and at least 2 hours.

The mixture subjected to step a is in most cases an acidic fermentation product, preferably a product of acidic fermentation of the at least one third flavouring agent. Best results are obtained when carrying out acidic fermentation using acetic acid.

In certain embodiments of the invention, one or more of the at least one first, second, and third flavouring agents are produced from the same starting material. In this way it e.g. becomes possible to produce an alcoholic beverage which balances the naturally occurring (often fragile) flavours found in a starting product, where these flavours are expressed at varying degrees in an alcohol fermented product and in a product of acidic fermentation.

The recovery in steps 3 and/or b is preferably performed by collecting vacuum distillation condensate fractions at different time points during the distillation process to obtain a plurality of collection time separated vacuum distillation fractions. As shown in the Example, the early fractions obtained in step 3 will have a high ethanol concentration, whereas later fractions will exhibit decreasing levels of ethanol. By undertaking this fractionation of the products of the distillation process(es), subsequent provision of an optimally flavoured end product is facilitated.

Typically, at least 10, such as at least 20, at least 30, and at least 40 collection time separated vacuum distillation fractions are collected in step 3 and optionally step b. In certain embodiments, about 50 fractions are collected and used to later compose the alcoholic beverage.

While it is possible to prepare the at least one first vacuum distillation condensate from one singe fraction from step 3, it is preferably constituted by a larger subset of the vacuum distillation fractions obtained in step 3. Likewise, the second vacuum distillation condensate is preferably constituted by a subset of the vacuum distillation fractions obtained in step 3 or a subset of the vacuum distillation fractions obtained in step b and can be constituted by merely one singe fraction.

At the end of the process, the subsets of fractions are typically mixed to obtain the alcoholic beverage to obtain a balanced flavour and ethanol concentration.

During the vacuum distillation process, it is necessary to separate the condensates continuously in order to obtain the above discussed fractions. This may be achieved in a number of ways, wherein one relies on distribution of fractions of condensate within the vacuum environment (e.g. by having a movable retort that over time leads the condensate to separate compartments in the distillation apparatus or by, alternative, having a moveable set of sampling compartments, e.g. compartment in a carrousel into which the condensate is dispensed. However, preferably the recovery in step 3 and/or b is carried by evacuating the vacuum distillation fraction from the vacuum environment without substantially modifying the vacuum—here evacuation is preferably effected via a positive displacement pump, such as a roller pump, a progressing cavity pump, a gear pump, and a roots-type pump. This facilitates sampling of fractions outside the vacuum in the distillation device.

Vacuum distillation in step 2 and/or b is carried out at a very low pressure (typically less than 1% of atmospheric pressure). Typical values range between 1 and 10 Torr.

One advantage of using vacuum distillation is that the boiling point of both water and ethanol is considerably lowered, which means that the temperature during the vacuum distillation in step 2 (and, if relevant, in step 1) is in the range between 5° C. and 30° C. For the vacuum distillation in step a, the temperature is typically somewhat higher, i.e. in the range between 15° C. and 40° C. This is i.a. the consequence of the fact that the distillation in step a is carried out on an aqueous product without any substantial amounts of alcohol.

To further facilitate the distillation, it has been found by the inventors that application of ultrasound to the distillation mixture facilitates evaporation without damaging flavours in the condensate produced. Hence, the vacuum distillation in step 2 and/or a is preferably carried out while applying ultrasound during at least part of the distillation process.

One convenient way of applying ultrasound is to employ an ultrasound emitting device situated in the interface between the mixture to be distilled and the vacuum space and/or situated in the upper 50% of the mixture. This can be achieved by using an ultrasound device that has a buoyancy below that of the mixture.

The ultrasound used in these preferred embodiments normally has a frequency in the range between 0.5 and 2.6 MHz; the frequency is preferably in the range 0.6-2.5 MHz, and preferably 0.7-2.4 MHz, 0.8-2.3 MHz, 0.9-2.2 MHz, 1.0-2.1 MHz, 1.1-2.0 MHz, 1.2-1.9 MHz, 1.3-1.8 MHz, and 1.4-1.7 MHz. A particularly preferred frequency is about 1.6 MHz.

The sources for the flavouring agents are typically those that include flavours that are hard/impossible to preserve satisfactorily if subjecting them to distillation at temperatures above 30 or 40° C. Preferably the at least one first and/or second and/or third flavouring agent is present in or obtained from a product selected from the group consisting of Aspergillus luchuensis; Aspergillus oryzae; Belgian Saison Yeast; a chili pepper product, including habanero fruit, habanero vinegar, pasilla, and pasilla kombucha; bergamot; birch and birch products, such as birch Kombucha; cocoa, including cocoa seeds and cocoa husks; Douglas Fir; gava products, including fava bean, fava bean husk, and fava bean husk vinegar; gooseberry; juniper; kefir lime; lemon verbena; meadowsweet; mosaic Hops; nacho cheese products, including nacho cheese flavored chips; naked barley; orange blossom; oysters; Pilsner Malt; Plum Kernel; quince products, including quince fruit, quince Tea, and quince tea kombucha; Ras El Hanout; Rice; wild pea flowers; Ambarana; Balsamo; Beet Molasses; Birds Eye Chili; Black Lime; Blackcurrent shoots; Bok Choi; Carob; Casava; Casca de Cambuci; Castanheira; Chaff; Cherry stems; Cinnamon; Citra Hops; Condensed Milk; Corn Husk; Cumaru; Eukanof Hops; Gentian; Goiabada; Gooseberry; Grains of Paradise; Grapefruit; Gunpowder Green Tea; Honey; Ipe; Jabuticaba; Jaqueira; Jequitiba; Lemon Verbena; Marula; Mate; Mazanje; Mufandichimuka; Nutmeg; Oolong Tea; Orris; Passionfruit; Peanuts; Peppercorns; Pimento Bontica; Pomelo; Pumpkin; Purple Wheat; Putumuju; Puxuri; Rhubarb; Sencha Green Tea; Sesame; Sugar beets; Sweet Potato; Szechuan Pepper; Tonca Bean; Torrando; Vetiver; Yin Xiang Green Tea; Agave Syrup; Ancho; Baby Peach; smoked fish, such as bakskuld; barley; Black Peppercorn; Butter; Celeriac; Ceylon Black Tea; Chorizo; Demerara Sugar; Dried Rose; Fermented Greens; Flat Leaf Parsley; Galangal; Genmai-Macha; Goji Berry; Green Acorn; Green Black Walnut; Green Cardamom; Green Pinecone; Green Sea Buckthorn; Green Tea; Ground Ivy; Gyokuro; Jamum Powder; Katsuo; Lavender; Lemon Thyme; Lemongrass; Lilac; Lovage; Morita; Mosaic Hops; Mugwort; Myrtle; Orange Blossom; Oyster Mushrooms; Pasilla; Pink Peppercorn; Purpur Hvede; Ramson; Rose; Rose Hip; Ruanda Black Tea; Smoked Mugicha; Smoked Sugar Kelp; Spent Grain Miso; Sumac Leaf; Takuan; Tansie Leaves; Tansie Stems; Toasted Savtang; Tumeric; Vietnamese Black Tea; a walnut product, such as walnut Leaves and walnuts; Water Mint; Weed; Yarrow Flower Buds, and; Yarrow Flowers.

Some of the at least one first and/or second and/or third flavouring agents can be in the form of preserved products, such as dried or pickled products or products very rich in sucrose, fat or NaCl, i.e. products that are dry or can be stored in a dry environment. These flavouring agents are typically obtained from a dried or dry-storable product selected from the group consisting of Agave Syrup, American Walnut, Ancho, Ancho, Angelica, Apple, Baby Peach, Bakskuld, Baobab, Barley, Bell Kelp, Birch, Black Peppercorn, Buckwheat, Butter, Cacao Flower, Cacao nib, Celeriac, Ceylon Black Tea, Chickpeas, Chorizo, Chrysotoxum, Davao Cacao Husk, Demerara Sugar, Dits, Douglas Fir, Dried Rose, Dulse, Fermented Greens, Flat Leaf Parsley, Galangal, Genmai-Macha, Hibiscus, Jamun Powder, Kombu, Mace, Mafura, Malted Barley, Maple syrup, Molasses, Moringa Leaf Powder, Oyster Mushrooms, Palm Sugar, Pearled Barley, Pepper Dulse, Rice, Soy Beans, Wheat, Woodruff

However, any food processing method can provide flavour characteristics to a flavouring agent, so the at least one first and/or second and/or third flavouring agent or the product from which it is derived may have been subject to processing selected from curing, smoking, freezing, barrel-aging, fermenting, pickling, smoking, drying, roasting, distilling, mashing, blending, infusing, and steaming.

A particularly interesting fermentation process that can provide for interesting flavouring agents is fermenting with Aspergillus oryzae, i.e. the fungus used as part of Koji fermentation. Also, traditional Koji fermentation processes are therefore useful in the present invention. A useful review of Koji fermentation and cultures useful for this purpose is e.g. available in Shurtleff W and Aoyagi A (2012): “The history of Koji”, ISBN 978-1-928914-45-7.

The end product of the method of the invention is an alcoholic beverage, which typically has an ethanol concentration in the range between 30% v/v and 80% v/v, such as about 30%, about 35%, about 40%, about 45%, and about 50%.

In the inventive process, the condensate is brought to liquid form during the process by cooling vapours in the distillation with liquid nitrogen or any other suitable cooling agent.

In the Example, one specific embodiment of the 1^{st} aspect of the invention is illustrated, and in Fig. is provided an illustration in the form of a flow chart showing an embodiment of the 1^{st} aspect of the invention with the following content:

| Box number | Content |
|---|---|
| 1 | Raw product Barley |
| 2 | Soak |
| 3 | Steam |
| 4 | Inoculate |
| 5 | Barley Koji |
| 6 | Raw product Pilsner Malt |
| 7 | Mill malt |
| 8 | Add water to mash tun |
| 9 | Add Barley koji to mash tun |
| 10 | Add malt to mash tun |
| 11 | Filtered wort |
| 12 | Sparging |
| 13 | Filtration |
| 14 | Unfiltered wort |
| 15 | Mashing |
| 16 | Fermentation |
| 17 | Wash |
| 18 | 1^{st} distillation 5-32° C. |
| 19 | Low wine |
| 20 | Add Botanicals |
| 21 | Steep for between 3-24 hours |
| 22 | Strain |
| 23 | 2^{nd} distillation between 5 and 38° C. |
| 24 | Separation of run into cuts |
| 25 | Distilled Spirits |
| 26 | 2^{nd} distillation between 5 and 38° C. |
| 27 | Separation of run into cuts |
| 28 | Distilled spirits |
| 29 | Testing and blending |
| 30 | Final product, release 1 |
| 31 | Final product, release 2 |
| 32 | Testing and blending |
| 33 | Distilled vinegar/kombucha |
| 34 | Bottling |
| 35 | Separation of run into cuts |
| 36 | Fermentation |
| 37 | Distillation 15-48° C. |
| 38 | Add Vinegar |
| 39 | Fermentation |
| 40 | Raw product botanical |
| 41 | Add Scoby |
| 42 | Strain Botanical |
| 43 | Steep in water for 3-24 hours |
| 44 | Raw product Botanical |

### Second Aspect of the Invention

All disclosure herein relating to process parameters and features of the method of the first aspect of the invention applies mutatis mutandis to the configuration of the device of the second aspect, and in general the second aspect is set forth in the claims.

The ultrasonic transducer may particularly be a floating ultrasonic transducer having a buoyancy below that of the liquid phase, e.g. below that of water. In that way, the ultrasonic transducer may be located in the interface between the liquid phase and gas phase derivable by the distillation process.

The ultrasonic transducer may comprise a floating body and one or more transducer elements arranged in or on the floating body. The transducer elements may e.g. comprise one or more piezo elements etc. for establishing an ultrasonic wave. Particularly, the transducer may emit the signals into an upper layer of the liquid phase, particularly a layer in the range of 1-4 cm. below the interface between liquid phase and gas phase.

The transducer elements may e.g. operate in the range between 0.9 and 2.6 MHz, e.g. between 1 and 2 MHz.

The device may further comprise a heater configured to heat the liquid phase in the distillation vessel, e.g. a heater configured for moderate heating, e.g. to a temperature in the interval 15-35 degrees, e.g. to 22-27 degrees.

The device may further comprise a control structure configured for simultaneous operation of the heater and the ultrasonic transducer. Simultaneous moderate heating and mist making by use of the transducer in vacuum may create distillation at a low temperature and thereby preserve fragile fragrances.

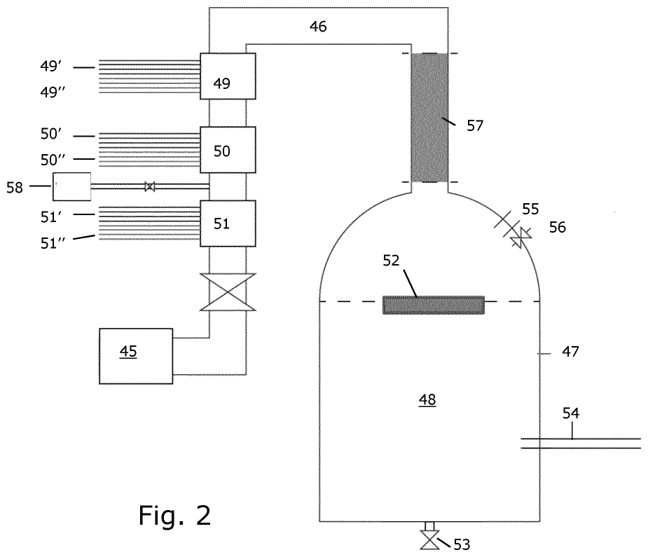

FIG. 2 illustrates a device for preparation of an alcoholic beverage constituting a specific embodiment of the second aspect of the invention. The illustrated device comprises a vacuum pump forming vacuum suction means 45. The vacuum pump is located downstream the distillation column 46 and is arranged to provide a pressure in the range of 1-20 percent of atmospheric pressure in the column and in the distillation vessel 47.

The distillation vessel 47 forms a distillation chamber 48 which is in fluid communication with the vacuum suction means via the distillation column 46.

A liquid phase of a primary ethanol-containing mixture is indicated by the dotted line 49. This liquid phase is subject to vacuum distillation and thereby provides a secondary ethanol-containing distillation condensate.

The device comprises a condenser structure comprising at least one condenser configured for providing a first vacuum distillation condensate as a fraction of the secondary condensate. The illustrated condenser structure comprises three condensers 49, 50, 51 communicating the condensate into three different collector vessel arrangements, each being capable of receiving hot glycol 49′, 50′, and 51′ and cold glycol 49″, 50″, and 51″. The illustrated condensers operate at different temperatures. A peristaltic pump (not illustrated) is arranged to extract liquid from collector vessels at or after each of the condensers.

A computer-controlled separation system is connected to the peristaltic pumps comprises a computerised controller for operating the peristaltic pump based on a timer counting a duration from a point in time where condensate enters the collector vessel. This feature enables separation of the condensate into different fragments, e.g. up to 50-100 different fragments.

The device further comprises an ultrasonic transducer 52 configured for establishing a mist of the liquid phase of the primary mixture in the vacuum distillation vessel. The ultrasonic transducer is constituted by a floating body and a number of transducer elements attached to the floating body.

A mixer is provided for mixing a primary ethanol-containing distillation condensate with a flavouring agent so as to prepare a primary mixture.

The ultrasonic transducer illustrated in FIG. 2 has transducer elements operable at a frequency of 1.7 MHz, however, other frequencies, e.g. in the range of 0.9-2.7 MHz could be used.

The device may comprise a number of additional components, a few of which are listed below:

The liquid to be distilled is inserted via the inlet 53. Heating is obtained by a heater receiving hot water via the hot water line 54. Vacuum sensors and temperature sensors 55 are arranged in the vessel, particularly above the liquid surface, i.e. above the transition between liquid and gas phase and above the ultrasonic transducer. The vacuum level can be reduced by use of the vacuum release valve 56, and a first part of the distillation column 57 is made from transparent or translucent material, e.g. glass. This enables visual control of the process. The vessel 58 illustrates one of several vessels arranged to receive the distilled liquid.

### Third Aspect of the Invention

It is believed by the inventors that preparation of alcoholic beverages by utilisation of vacuum distillation at low temperatures (i.e. temperatures below 40° constitutes an invention in its own right). The preservation of flavours and fragrances observed in the products obtained when carrying out the above-described process demonstrates that the choice of vacuum distillation at these low temperatures provides for unexpected advantages in terms of the end-user experience.

Whether vacuum distillation is implemented directly on a fermentation product or on a condensate obtained after a primary distillation of a fermentation product is immaterial; of relevance is the preservation of “native” flavours present in the ethanol-containing liquid that are likely to change/disintegrate during traditional distillation processes that rely on use of higher temperatures.

Important embodiments of the 3^{rd} aspect of the invention utilise parameters, settings and conditions as described in detail for the 1^{st} aspect; thus, the number of the plurality of ethanol containing fractions is preferably as described above, and the same is true for the temperature and pressure settings.

Importantly, the method steps described above for carrying out the vacuum distillation in step 2 (and, when relevant, step 1) of the first aspect of the invention are important embodiments of the 3^{rd} aspect. Therefore, vacuum distillation is preferably carried out while applying ultrasound during at least part of the distillation process, and in preferred embodiments this is done as described above in relation to the 1^{st} aspect of the invention. Also, the continuous sampling of fractions of condensate as described above is applicable for recovery of the plurality of fractions in the 3^{rd} aspect of the invention. Finally, as is the case for the 1^{st} aspect of the invention, the ethanol-containing mixture being subjected to the vacuum distillation preferably contains at least one flavouring agent, preferably a flavouring disclosed above under the discussion of the first aspect of the invention. Thus, the flavouring agent(s) may be “carried over” in the initial fermentation product, and/or it may be added between two steps of distillation.

### Example 1

Production of an Alcoholic Beverage

In the following is provided an example of preparation of an alcoholic beverage combined from a distilled Koji fermented product and a distilled brewing product.

Koji Fermentation

1. All raw ingredients are tasted and visually inspected to be of the desired quality at delivery.

2. 550 kg of (dry) Pearl Barley is measured out.

3. The barley is soaked in water for between 30 minutes and 4 hours depending on ambient humidity and temperature. Water absorption is evaluated from visual inspection and taste.

4. Water is strained off and the soaked barley is transferred to a steaming chamber (a converted butter churner).

5. Barley is at 80°−100° C. for 1 h-6 h depending on amount and ambient temperature and humidity.

6. After steaming, about 600 kg cooked grain is produced as a consequence of absorption of moisture. Also here, visual inspection and taste is used for evaluation: The outer shell should be translucent, and yellowish in colour.

7. Steamed grain is transferred to Koji Muro (a humidity and temperature controlled room, which sits at 35-40° C. and 60-70% humidity).

8. Temperature of grain is checked and subsequently the grain is cooled, by turning and breaking up the grains by hand, 37° C., while checking that temperature and cook are even.

9. The grain is inoculated with Aspergillus oryzae Koji Kin by dusting the spores over the cooked grain, approximately 1 g A. oryzae per kg grain.

10. The grains are mixed several times to spread the spores, and the grains are subsequently spread out in an even layer on beds, covered with a cloth, and left to rest for 16 h.

11. All grains should have developed tiny white spots—not green or black spots.

12. Grains are mixed and spread evenly out again and left to rest for another 24 h.

13. At the end of the Koji fermentation, the Barley Koji should consist of clumps of even white, cakey, moldy grains with a mushroom-like, floral smell and sweet taste.

Brewing

1. The exemplary brewing process utilises approximately 60% Pilsner Malt and 40% Barley Koji (eg 550 kg Pilsner malt and 300 kg Koji).

2. 1200 l of soft water, pH 5.8-6, is added to mash tun, and Barley Koji is added.

3. Milling is performed by pumping the water and Barley Koji mix from the mash tun to a wet hammer mill and back again continuously for about 55 minutes, while gradually adding the Pilsner Malt gradually in a closed cycle.

4. Mashing rests, where different brewing temperatures are maintained to encourage specific enzymatic activities with the goal of specific sugar conversions is performed as follows: 15 minutes protein rest at 45° C.; first saccharification rest at 62° C.; second saccharification rest at 66.5° C. After this, conversion of starches into sugars checked. If the level is satisfactory, step 5 is instigated, otherwise the temperature is maintained for a prolonged period. Finally, temperature is increased to 76° C. and filtration is started.

5. The product is filtered back into the brew system through a mash filter.

6. Mashing is followed by sparging, where hot water (80° C.) is pumped through the filter and into the brew system to extract more sugars, until the wort hits 10 brix. the result is a total of approximately 1800 l, 20 brix, of filtered wort in the brew system.

7. The filtered wort is run through a plate chiller, and cooled down to 23° C.

8. The wort is aerated to 10 parts per million of oxygen to aid fermentation.

9. The wort is transferred to fermentation tanks and inoculated with yeast, 6 g/l; alternatively, this inoculation can be measured as numbers of cells per degrees plato per ml.

11. The fermentation is capped at 26° C.

12. The brix and pH values are measured every day until they reach 3.5 plato or 3.56 PH.

13. The resulting product is ‘Wash’.

Distilling

1. 500-1,500 l Wash is transferred to the distillation device for a stripping run, at 30° C. under a vacuum of 6-8 torrs, i.e. between 8/1,000 and 10/1,000 of atmospheric pressure.

2. The Stripping Run remains unblended and goes straight into 180 l stainless steel barrels. the early parts of the stripping run have about 45% ABV and the process is stopped once the distillate hits 12% ABV.

3. The distillates are combined, starting from the “early” barrels until a 30% ABV low wine is obtained.

4. The low wine is re-distilled in the ‘Spirit run’ which starts at 70% ABV—temperature and pressure is as in step 2. The distillate is run into 5 l vessels until the distillate hits 25% ABV, thereby obtaining a series of 5 l fractions of distillate of varying ABV

5. Approximately 20% of the first cuts are discarded to make sure methanol is excluded.

6. The remaining fractions are blended to reach the taste desired.

1. A method for preparation of an alcoholic beverage, the method comprising mixing at least one first vacuum distillation condensate and at least one second vacuum distillation condensate, wherein the at least first vacuum distillation condensate can be or is obtained by the steps of
1) distilling an ethanol-containing fermentation mixture, to produce a primary ethanol-containing distillation condensate, which optionally also contains at least one first flavouring agent derived from the fermentation product,
2) optionally mixing the primary ethanol-containing distillation condensate with at least one second flavouring agent before subjecting the liquid phase of the resulting mixture or, if no second flavouring agent has been used, the primary ethanol-containing distillation condensate to vacuum distillation to obtain a secondary ethanol-containing distillation condensate, which comprises an amount of the at least first flavouring agent or the at least one second flavouring agent or both the at least first and at least second flavouring agent, and
3) recovering the first vacuum distillation condensate in the form of a fraction of the secondary condensate obtained in step 2,
and wherein the second vacuum distillation condensate can be or is obtained by either
a) vacuum distilling a mixture comprising a weak acid and at least one third flavouring agent to produce an acidic distillation condensate, which comprises an amount of the at least one third flavouring agent, and
b) recovering the second vacuum distillation condensate in the form of a fraction from the acidic distillation condensate obtained in step a;
or
c) by steps 1-3, where the second vacuum distillation condensate is recovered in the form of a different fraction of the secondary condensate obtained in step 2 than the fraction constituting the first vacuum distillation condensate.

2. The method according to claim 1, wherein the fermentation product in step 1 is the liquid phase from an ethanol fermentation process.

3. The method according to claim 1 or 2, wherein the at least one first flavouring agent is a biological product, which optionally has been subjected to fermentation.

4. The method according to claim 1, wherein the mixing of the primary ethanol-containing distillation condensate and the at least one second flavouring agent is followed by an incubation period of at least 2 hours and at most 10 days prior to carrying out the vacuum distillation.

5. (canceled)

6. (canceled)

7. The method according to claim 1, wherein the mixture in step a is an acidic fermentation product.

8. (canceled)

9. The method according to claim 1, wherein recovery in step 3 and/or step b is performed by collecting vacuum distillation condensate fractions at different time points during the distillation process to obtain a plurality of vacuum distillation condensate fractions, which are separated by their collection time points.

10. The method according to claim 9, wherein at least 10 vacuum distillation condensate fractions are collected in step 3 and optionally b.

11. The method according to claim 9, wherein the first vacuum distillation condensate is constituted by a subset of the vacuum distillation fractions obtained in step 3.

12. The method according to claim 9, wherein the second vacuum distillation condensate is constituted by a subset of the vacuum distillation fractions obtained in step 3 or a subset of the vacuum distillation fractions obtained in step b.

13. The method according to claim 11, wherein the subsets of fractions are mixed to obtain the alcoholic beverage to obtain a balanced flavour and ethanol concentration.

14. The method according to claim 1, wherein the recovery in step 3 and/or b is carried by evacuating the vacuum distillation fraction without substantially modifying the vacuum.

15. The method according to claim 1, wherein vacuum distillation in step 2 is carried out at a pressure in the range between 1 and 10 Torr, and wherein vacuum distillation in step a is carried out at a pressure in the range between 1 and 10 Torr, and wherein the temperature during the vacuum distillation in step 2 is in the range between 5° C. and 30° C. and wherein the temperature during the vacuum distillation in step a is in the range between 15° C. and 40° C.

16. (canceled)

17. The method according to claim 1, wherein the vacuum distillation in step 2 and/or step a is carried out while applying ultrasound during at least part of the distillation process.

18. (canceled)

19. (canceled)

20. (canceled)

21. The method according to claim 17, wherein the frequency of the ultrasound is about 1.6 MHz.

22. The method according to claim 1, wherein the at least one first and/or second and/or third flavouring agent is present in or obtained from a product selected from the group consisting of Aspergillus luchuensis; Aspergillus oryzae; Belgian Saison Yeast; a chili pepper product, including habanero fruit, habanero vinegar, pasilla, and pasilla kombucha; bergamot; birch and birch products, such as birch Kombucha; cocoa, including cocoa seeds and cocoa husks; Douglas Fir; gava products, including fava bean, fava bean husk, and fava bean husk vinegar; gooseberry; juniper; kefir lime; lemon verbena; meadowsweet; mosaic Hops; nacho cheese products, including nacho cheese flavored chips; naked barley; orange blossom; oysters; Pilsner Malt; Plum Kernel; quince products, including quince fruit, quince Tea, and quince tea kombucha; Ras El Hanout; Rice; wild pea flowers; Ambarana; Balsamo; Beet Molasses; Birds Eye Chili; Black Lime; Blackcurrent shoots; Bok Choi; Carob; Casava; Casca de Cambuci; Castanheira; Chaff; Cherry stems; Cinnamon; Citra Hops; Condensed Milk; Corn Husk; Cumaru; Eukanof Hops; Gentian; Goiabada; Gooseberry; Grains of Paradise; Grapefruit; Gunpowder Green Tea; Honey; Ipe; Jabuticaba; Jaqueira; Jequitiba; Lemon Verbena; Marula; Mate; Mazanje; Mufandichimuka; Nutmeg; Oolong Tea; Orris; Passionfruit; Peanuts; Peppercorns; Pimento Bontica; Pomelo; Pumpkin; Purple Wheat; Putumuju; Puxuri; Rhubarb; Sencha Green Tea; Sesame; Sugar beets; Sweet Potato; Szechuan Pepper; Tonca Bean; Torrando; Vetiver; Yin Xiang Green Tea; Agave Syrup; Ancho; Baby Peach; smoked fish, such as bakskuld; barley; Black Peppercorn; Butter; Celeriac; Ceylon Black Tea; Chorizo; Demerara Sugar; Dried Rose; Fermented Greens; Flat Leaf Parsley; Galangal; Genmai-Macha; Goji Berry; Green Acorn; Green Black Walnut; Green Cardamom; Green Pinecone; Green Sea Buckthorn; Green Tea; Ground Ivy; Gyokuro; Jamum Powder; Katsuo; Lavender; Lemon Thyme; Lemongrass; Lilac; Lovage; Morita; Mosaic Hops; Mugwort; Myrtle; Orange Blossom; Oyster Mushrooms; Pasilla; Pink Peppercorn; Purpur Hvede; Ramson; Rose; Rose Hip; Ruanda Black Tea; Smoked Mugicha; Smoked Sugar Kelp; Spent Grain Miso; Sumac Leaf; Takuan; Tansie Leaves; Tansie Stems; Toasted Savtang; Tumeric; Vietnamese Black Tea; a walnut product, such as walnut Leaves and walnuts; Water Mint; Weed; Yarrow Flower Buds, and; Yarrow Flowers.

23. The method according to claim 1, wherein the at least one first and/or second and/or third flavouring agent is present in or obtained from a dried or dry-storable product selected from the group consisting of Agave Syrup, American Walnut, Ancho, Ancho, Angelica, Apple, Baby Peach, Bakskuld, Baobab, Barley, Bell Kelp, Birch, Black Peppercorn, Buckwheat, Butter, Cacao Flower, Cacao nib, Celeriac, Ceylon Black Tea, Chickpeas, Chorizo, Chrysotoxum, Davao Cacao Husk, Demerara Sugar, Dits, Douglas Fir, Dried Rose, Dulse, Fermented Greens, Flat Leaf Parsley, Galangal, Genmai-Macha, Hibiscus, Jamun Powder, Kombu, Mace, Mafura, Malted Barley, Maple syrup, Molasses, Moringa Leaf Powder, Oyster Mushrooms, Palm Sugar, Pearled Barley, Pepper Dulse, Rice, Soy Beans, Wheat, and Woodruff

24. The method according to claim 1, wherein the at least one first and/or second and/or third flavouring agent or the product from which it is derived has been subject to processing selected from curing, smoking, freezing, barrel-aging, fermenting, pickling, smoking, drying, roasting, distilling, mashing, blending, infusing, and steaming.

25. The method according to claim 24, wherein fermenting is Aspergillus oryzae fermentation.

26. (canceled)

27. (canceled)

28. The method according to claim 1, wherein distilling in step 1 is carried out by vacuum distilling the ethanol-containing fermentation mixture.

29. (canceled)

30. A method for producing an alcoholic beverage, the method comprising subjecting an ethanol-containing liquid derived from a fermentation process to at least one step of vacuum distillation performed at a temperature that does not exceed 40° C., recovering a plurality of ethanol-containing fractions at different time points during the final step of vacuum distillation, and subsequently either combining liquid from at least two of the plurality of ethanol-containing fractions to obtain the final alcoholic beverage or obtaining the final alcoholic beverage from one single of the ethanol-containing fractions.

31. The method according to claim 30, wherein
the number of the plurality of ethanol containing fractions is at least 10;
the temperature during the vacuum distillation is in the range between 5° C. and 30° C.;
the pressure during vacuum distillation is.

32. The method according to claim 30, wherein vacuum distillation is carried out while applying ultrasound during at least part of the distillation process.

33. The method according to claim 30, where the plurality of fractions are recovered by evacuating the vacuum distillation fraction without substantially modifying the vacuum.

34. The method according to claim 30, wherein the ethanol-containing mixture contains at least one flavouring agent.

35. A device for preparation of an alcoholic beverage, the device comprising
vacuum suction means,
a distillation vessel forming a distillation chamber in fluid communication with the vacuum suction means and configured for subjecting a liquid phase of a primary ethanol-containing mixture to vacuum distillation to obtain a secondary ethanol-containing distillation condensate, and
a condenser structure comprising at least one condenser configured for providing a first vacuum distillation condensate as an fraction of the secondary condensate,
the device further comprising an ultrasonic transducer configured for establishing a mist of the liquid phase of the primary mixture in the vacuum distillation vessel, and the device further optionally comprising a mixer for mixing a primary ethanol-containing distillation condensate with the second flavouring agent so as to prepare the primary mixture.

36. The device according to claim 35, wherein the ultrasonic transducer has a density below 1 g per cubic millimetre.

37. The device according to claim 35, wherein the ultrasonic transducer is operable in a frequency range of 0.9-2.6 MHz.

38. The device according to claim 35, wherein the transducer forms a horizontal surface with an area constituting at least 10 pct. of a horizontal cross section of the distillation chamber (surface of the liquid phase of the primary mixture in the vacuum distillation vessel).

39. The device according to claim 35, wherein the vacuum suction means is configured to reduce pressure in the distillation chamber to less than half of an ambient pressure outside the distillation chamber.

40. The device according to claim 35, wherein the vacuum suction means and the ultrasonic transducer are operable simultaneously to create mist in vacuum.

41. The device according to claim 35, comprising a collector system comprising a plurality of collector vessels, each in fluid communication with a condenser and arranged for collection of a condensate from the condenser.

42. The device according to claim 35, wherein each condenser is configured for condensation at a temperature distinct from that of other condensers of the device.

43. The device according to claim 42, wherein the collector system comprises at least one peristaltic pump configured to extract liquid from at least one of the collector vessels and add the extracted liquid to a mixing chamber.

44. The device according to claim 42, wherein the separation system comprises a computerised controller for operating the peristaltic pump.

45. The device according to claim 44, wherein the computerised controller is configured to operate based on data determining a split between predefined fractions in the condensate in the collector vessel to thereby create separation of the condensate.

46. The device according to claim 44, wherein the separation system comprises a computerised controller for operating the peristaltic pump based on a timer.

47. The device according to claim 46, wherein the timer is configured to count a duration from a point in time where condensate enters the collector vessel.

48. The device according to claim 43, wherein the peristaltic pump is operable simultaneous with the vacuum suction means.

49. The device according to claim 43, wherein the peristaltic pump is operable simultaneous with the ultrasonic transducer.

50. The device according to claim 43, wherein the peristaltic pump is operable simultaneous with a heater arranged to heat the liquid phase in the distillation vessel.
